(19) United States
(12) Patent Application Publication
(10) Pub. No.: US 2010/0003659 A1
(43) Pub. Date: Jan. 7, 2010

(54) COMPUTER-IMPLEMENTED LEARNING METHOD AND APPARATUS

(76) Inventor: Philip Glenny Edmonds, Oxford (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/449,406

(22) PCT Filed: Feb. 7, 2008
(86) PCT No.: PCT/JP2008/052479

§ 371 Date: Aug. 6, 2009

(30) Foreign Application Priority Data
Feb. 7, 2007 (GB) 0702298.1

(51) Int. Cl. G09B 5/00; G09B 7/00

(52) U.S. Cl. 434/350; 434/362

(57) ABSTRACT

A computer-implemented adaptive learning method is disclosed. The method is intended for performance within the context of a task being carried out by a user. At least one of a sequence of elements presented to the user as part of the task is designated as a learning item. A learning object is selected in dependence upon the designated learning item, information relating to previous performance of the learning method in relation to the user, and a predetermined scheme devised to manage an overall learning process for the user. Presentation of the selected learning object to the user is intended to advance the user's knowledge of the designated learning item in some way. Once the learning object has been presented to the user, the information is updated in dependence upon the presented learning object and/or how the user interacts with or responds to the presented learning object.

### TECHNICAL FIELD

The present invention relates to a computer-implemented learning method and apparatus. The present invention is applicable to learning any subject or skill, but is particularly but not exclusively applicable to language learning.

### BACKGROUND ART

Learning certain skills, subjects, or bodies of knowledge is often a long term process that can take many years. In the case of learning a language, for example, knowledge about a word is accumulated over time by deliberate study, practice, and through incidental encounters in, for example, reading and conversation.

Recent theories of learning stress the need to learn by doing in addition to using deliberate study and practice. Such theories claim that learning is more effective and motivating in the context of meaningful task-based activities (called contextualization) and when authentic, rather than artificial, content is used. In theory, a person can learn a skill more effectively while they perform a separate but related task or activity that requires the skill, rather than through an artificial task or exercise designed specially for learning the skill. In language learning, for example, extensive reading is a method in which language skills such as grammar or vocabulary are learned by reading large amounts of authentic text at the right level for fluent reading. Extensive reading is very motivating for students, since they can read fluently and reach a sense of achievement doing something they like. Other examples of authentic tasks for language learning include, but are not limited to, conversation, watching or listening to a movie, writing a report or a letter, translating a document, using a dictionary, playing a game that involves interaction using language. An authentic task is one that has not been designed for the sole purpose of supporting a learning method; that is, it can be performed in its own right independently from learning a related skill.

Learning a language requires one to learn the fundamental aspects of the language including vocabulary, grammar, and pronunciation as well as the four basic skills of reading, writing, listening, and speaking. Because it can take a long period of time to learn a language (native or second language), it has been found that management can make the learning process more effective and more efficient. It has been found, for example, that different aspects of knowledge about a word are best learned in small steps by progressing from word form (spelling and pronunciation), to meaning, and then to usage in phrases and sentences. In addition, words are more efficiently learned roughly in order of word difficulty, which correlates with frequency of use in the language (as described by I. Nation in Learning Vocabulary in Another Language published by Cambridge University Press, 2001). The process of learning vocabulary, and other aspects of a language, must be carefully directed and managed over time to achieve successful results, efficiency, and to maintain motivation in learning. In addition, every learner progresses at their own pace, so there is a need for personalized management.

However, the requirement for directed learning somewhat conflicts with the requirement for contextualized learning, since one does not want to unduly interrupt the authentic task, say, of reading, to find out, say, the pronunciation or the meaning of an unknown word, especially when that word is better left until later since it is too difficult for the present stage of the learner. Moreover, different information or activities will be required each time a word is encountered because the learner's knowledge will advance over time, and finding the right information can be time-consuming. On the other hand, not having that information could also affect reading fluency, and more generally, adversely affect the performance of the task. What is needed is to quickly present information or an activity (which changes over time) that will advance learning but not unduly affect task performance, thus providing an effective and motivational learning system. That is, what is needed is an effective combination of contextualized and directed learning methods that can adapt to a learner.

Traditional methods for managing the learning process are human-centered. For example, a teacher decides what curriculum, strategies, exercises, and learning materials should be used. Such methods are labor-intensive and not easy to personalize to the needs of an individual learner. A learner can also manage their own learning using self-directed methods, but the burden of manual management can be large, resulting in inefficiencies, discouragement, and unsuccessful learning. For example, a learner can consult a dictionary every time an unknown word is encountered and then find in the dictionary entry the right aspect of word knowledge that is needed, but this distracts the learner from the reading task, making reading difficult.

A variety of devices and computer systems have been developed to assist and manage language learning during the performance of an authentic task. For example, reading assistance systems allow a person to read a text and at the same time learn language skills such as vocabulary or grammar. It is well known in the prior art how to display or present various types of information about a word when it is selected from a text, including information such as word translation, word definition (U.S. Pat. No. 6,632,094), example sentences (U.S. Pat. No. 5,256,607), spoken pronunciation (LeapPad® device by LeapFrog® Enterprises), and multimedia presentations. Such methods do not adapt to the user and always present the same information (e.g., always present a word definition when a word is selected, or simply alternate between different types of information). They do not help the learner to progress.

An Intelligent Tutoring System or Instructional Expert System is an adaptive computer-based solution. The general structure of such systems is well known in the prior art, including steps such as presenting one or more exercises to the user, tracking a user's performance in a user model, making inferences about strengths and weaknesses of a learner using an inference engine and an instructional model, and adapting the system's responses by choosing one or more appropriate exercises to present next according to an instructional model. Such systems are typically built into question-and-answer sequences or human-computer dialog systems. In one example of prior art, the REAP system (Heilman and Eskenazi, “Language Learning: Challenges for Intelligent Tutoring Systems”, in the Workshop on Intelligent Tutoring Systems for Ill-Defined Domains, 2006) finds documents that contain vocabulary that the student has not yet learned. The system first tests the student on his or her current vocabulary knowledge by automatically generating a vocabulary exercise for each word on a pre-defined list of words. It then finds a document that contains one or more words that the student has not yet learned. After the student reads the document, the system generates more vocabulary exercises about the target words to determine if learning has occurred. The system then selects subsequent reading material. The REAP system involves two types of task: an artificial task of solving vocabulary questions before and after reading and an authentic task of reading a document. However, the system can only adapt to the user during the artificial question-answering task, a task that is time-consuming and de-motivating for the user. It does not adapt or present appropriate educational content while the user is reading the document. In general, such Intelligent Tutoring Systems are not contextualized. The task in such systems is artificial because it is generated by the system for mainly pedagogical purposes as a series of questions or as a human-computer dialog.

Another type of adaptive system is a flash-card, or cue-and-response system, which embodies the principle of learning as memorization. U.S. Pat. No. 5,585,083 provides a system that presents an exercise for vocabulary learning (a cue), receives a response, evaluates the response, and provides feedback to the user. In U.S. Pat. No. 6,652,283, a similar system presents information to be learned as a cue and monitors user responses, but is designed to maximize memory retention based on cognitive models. The timing, order of presentation, and order of cue and response is adapted to the user by monitoring user accuracy and response times. Such cue-and-response systems can immediately adapt to a user but since they are based on memorization in an artificial context they also do not work in the context of authentic tasks.

Another type of adaptive system aims to provide intelligent assistance to a user when they are experiencing difficulty in performing a task, although it is not an educational system. For example, U.S. Pat. No. 6,262,730 describes an Expert System that monitors user actions in a software program, such as a word processor, from which it infers user intentions and information needs in order to provide assistance in the operation of the software program. In addition, the system includes a Bayesian network implementation of an inference system, and a user model that maintains a persistent record of user competencies such as completion of actions in the program, successful use of features in the program, or help reviewed. The inference system makes decisions based on user activity in the program and past use of program features. Such a system, exemplified by the above system, adapts within the context of an authentic task, however it is not a language learning system. It aims to help the user to perform a very specific action, such as saving a file, and is not capable of the stepwise management process that would progressively advance the user's knowledge of a language.

Other related prior art includes: U.S. Pat. Nos. 6,077,085, 6,801,751, 6,017,219, 6,986,663, 6,206,700, 6,022,221, 5,842,868, 6,953,343, 6,212,358, 6,405,167, 5,920,838, U.S. Pat. Appls. 2006/063139, 2001/031456, 2005/196733, 2005/084830, 2002/098463, the LeapPad® device by Leapfrog® Enterprises (and other interactive and ‘talking’ books).

In summary, no prior art system provides an effective contextualized language learning system because none combines personalization, management, adaptivity, and contextualization. Some prior art systems for language learning are not adaptive: they provide the same learning experience every time regardless of learner progress. Other prior art systems are adaptive. One class of such adaptive systems is not contextualized: it adapts only through an artificial educational task that can be modeled and controlled by an Intelligent Tutoring System. A second class is contextualized but merely provides a help facility that is not capable of managing a language learning process.

What is needed is a contextualized system for language learning that can manage a language learning process that is separate from an authentic task (that requires language skills) while the task is being performed by a learner. Furthermore, what is needed is a system that can adapt to a learner's growing knowledge of a language while the learner performs the separate task so that the system can present the right learning activities to advance the learner's knowledge without unduly affecting performance in the task, thus maintaining user motivation in learning.

### DISCLOSURE OF INVENTION

The basic concept of an embodiment of the present invention will now be described.

An embodiment of the present invention provides a contextualized adaptive educational system for language learning. The system works while a learner is performing a task that requires skill in language, such as reading a book or having a conversation. The system combines 1) a task interface for performing the task with 2) a learner-tracking component, which tracks learner performance in language learning activities, and 3) a decision-making component that chooses on the basis of the tracking and the context the right language learning activities for the learner. Thus the system can adapt to the learner's growing knowledge or skill with a language, and can provide personalized management in context of a task, which effectively advances the user's knowledge.

In one embodiment, an adaptive educational system for vocabulary learning works while a learner reads a book. The system tracks the learner's growing knowledge of vocabulary, such as words or phrases, in a history component. When a learner selects a word while he or she is reading a book, a decision-making process decides an appropriate language learning activity or other information to present to the learner by considering the learner's current knowledge of the word (as tracked during the current and previous reading tasks) and a variety of factors derived from the effective management of vocabulary learning. After the learner views or interacts with the learning activity, the system updates the history, thus completing a loop of tracking the learner's growing knowledge.

Any kind of language learning activity, or learning object, is supported by the system, although it is preferred that they be short activities so as not to distract the learner from performing the main task. Examples of general types of activity include, but are not limited to, displaying information, giving a hint, running a learning exercise or game, or providing a tutorial.

The decision-making process can include any type of decision-making component or components including, for example, a fixed pattern or sequence of activities, a manually created decision tree, a decision tree generated by automatic decision tree learning, a method based on machine learning, an expert system (which can include a procedural inference engine and a separate rule base incorporating an instructional model about a target subject), or any other inference system.

Any task that requires language can be supported by the system, including reading, writing, listening, speaking, translation, and conversation tasks. Any aspect of language can be tracked and taught including vocabulary, grammar, pronunciation, and discourse.

The adaptive educational system can be implemented on a portable educational device such as an electronic book-reading device, in a software program implemented on a personal computer, in a Web-based server accessed by a computer device, in a Personal Digital Assistant (PDA), among others.

The adaptive educational system can be applied to other domains, subjects, disciplines, and skills, such as mathematics, natural sciences, social sciences, music, art, geography, history, culture, technology, business, economics, and a variety of training scenarios, not limited by this list.

An embodiment of the present invention has one or more the following advantages.

An advantage of the system is that it can provide an effective means to learn a language and at the same time maintain learner motivation, since the system combines a contextualized approach to language learning (that is, learning by doing), with a direct approach that involves careful stepwise management to grow a learner's knowledge.

A further advantage of the system is that it can adapt to a learner and thus advance the learner's knowledge of a language by providing the right information or activities, which changes over time, each time an item is selected in the context of an ongoing task.

A further advantage is that the system can provide personalized management of a complex learning process, both freeing up a user to focus on learning rather than management, and providing personalized management unique to a learner's needs and pace of learning.

The system is especially suitable to subjects or skills in which knowledge must be accumulated and studied over long periods of time, such as a human language.

A further advantage is that the system can interrupt the user as little as is necessary in order to maintain fluent performance of the task, depending on different modes of operation.

A further advantage is that the system can advance the learner's knowledge of a subject or skill using pedagogically sound and effective principles.

A further advantage is that the user's history can be accessed and updated by external systems such as review systems, test systems, question-and-answer systems, operator's interfaces, learning management systems, e-learning systems, and so on. Thus the proposed system can form part of a comprehensive language learning platform.

A further advantage is that the system can be implemented as a single apparatus or split between a separate task interface and an adaptive learning component that are coupled together.

An embodiment of the present invention relates in general to educational systems or devices, and more specifically to educational systems or devices that adapt to a learner's growing knowledge of a subject or skill. Embodiments are applicable to learning any subject or skill, but are especially useful in language learning.

Aspects of the present invention will now be described.

According to a first aspect of the present invention there is provided a computer-implemented adaptive learning method, for performance within the context of a task being carried out by a user, the method comprising: designating as a learning item at least one of a sequence of elements presented to the user as part of the task; selecting a learning object in dependence upon the designated learning item, information relating to previous performance of the learning method in relation to the user, and a predetermined scheme devised to manage an overall learning process for the user, presentation of the selected learning object to the user being intended to advance the user's knowledge of the designated learning item in some way; presenting the learning object to the user; and updating the information in dependence upon the presented learning object and/or how the user interacts with or responds to the presented learning object.

Preferred embodiments of the present invention are set out in the appended dependent claims.

According to a second aspect of the present invention there is provided a computer-implemented adaptive learning method, for performance within the context of a task being carried out by a user, the method comprising: selecting a learning object in dependence upon a designated learning item, the designated learning item comprising at least one of a sequence of elements presented to the user as part of the task, and upon information relating to previous performance of the learning method in relation to the user, and upon a predetermined scheme devised to manage an overall learning process for the user, presentation of the selected learning object to the user being intended to advance the user's knowledge of the designated learning item in some way; and updating the information in dependence upon the selected learning object and/or how the user interacts with or responds to the selected learning object.

According to a third aspect of the present invention there is provided an adaptive learning apparatus for use in performing an adaptive learning method within the context of a task being carried out by a user, the apparatus comprising: means for designating as a learning item at least one of a sequence of elements presented to the user as part of the task; means for selecting a learning object in dependence upon the designated learning item, information relating to previous performance of the learning method in relation to the user, and a predetermined scheme devised to manage an overall learning process for the user, presentation of the selected learning object to the user being intended to advance the user's knowledge of the designated learning item in some way; means for presenting the learning object to the user; and means for updating the information in dependence upon the presented learning object and/or how the user interacts with or responds to the presented learning object.

According to a fourth aspect of the present invention there is provided an adaptive learning apparatus for use in performing an adaptive learning method within the context of a task being carried out by a user, the apparatus comprising: means for selecting a learning object in dependence upon a designated learning item, the designated learning item comprising at least one of a sequence of elements presented to the user as part of the task, and upon information relating to previous performance of the learning method in relation to the user, and upon a predetermined scheme devised to manage an overall learning process for the user, presentation of the selected learning object to the user being intended to advance the user's knowledge of the designated learning item in some way; and means for updating the information in dependence upon the selected learning object and/or how the user interacts with or responds to the selected learning object

According to a fifth aspect of the present invention there is provided a program for controlling an apparatus to perform a method according to the first or second aspect of the present invention or which, when loaded into an apparatus, causes the apparatus to become an apparatus according to the third or fourth aspect of the present invention. The program may be carried on a carrier medium. The carrier medium may be a storage medium. The carrier medium may be a transmission medium.

According to a sixth aspect of the present invention there is provided an apparatus programmed by a program according to the third aspect of the present invention.

According to a seventh aspect of the present invention there is provided a storage medium containing a program according to the third aspect of the present invention.

### BRIEF DESCRIPTION OF DRAWINGS

FIG. 1 is a block diagram of an adaptive educational system;

FIG. 2 is a flowchart of a learning management process;

FIG. 3 is a flowchart of a generic decision-making process;

FIG. 4 is a flowchart of a decision-making process for vocabulary learning;

FIG. 5 is a block diagram of a computer system;

FIG. 6 is a front view of a device and user interface;

FIG. 7 is a front view of a device and user interface; and

FIG. 8 is a front view of a device and user interface.

### BEST MODE FOR CARRYING OUT THE INVENTION

A preferred embodiment of the present invention provides an adaptive educational system for language learning, and in particular, vocabulary learning. The system runs while a user is performing a separate task such as reading a text or a book. The task is preferably an authentic task that the user would anyway be choosing independently to perform, one that is not designed for the sole purpose of supporting the adaptive learning method; the notion of an “authentic task” is discussed in further detail hereinbefore. The system can adapt to the user's growing knowledge about vocabulary by tracking the user's interaction with learning objects in the context of reading the text or book. Each time a user selects a word or phrase in the text or book, the system determines what learning object would best advance the user's knowledge of the word or phrase. The learning objects provide information, explanations, hints, short activities, or tutorials about word knowledge covering various aspects of vocabulary knowledge that can include form, meaning, and usage.

In the following specification, when we write the term “text” we mean the text of any reading material such as, but not limited to, a book, a newspaper, a document, or a Web page in paper (printed) or electronic format. When we write the term “word” we mean word, phrase, or any other short segment of text.

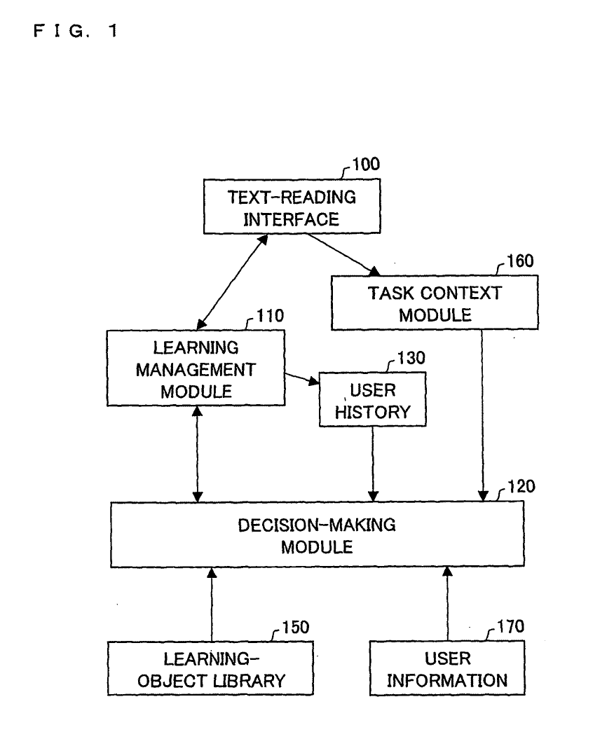

FIG. 1 is a block diagram of the components of the preferred embodiment of an adaptive educational system for language learning. A user reads a text through a text-reading interface 100. In the embodiment, the text-reading interface 100 can provide information about the current context of reading to the task context module 160, such as the current page number. The task context module 160 receives and stores context records and provides these to the decision-making module 120, as necessary. The text reading interface 100 also communicates with the learning management module 110 in order to activate a learning cycle. The learning management module 110 manages, for the user, the process of learning knowledge about vocabulary, overseeing a predetermined scheme devised to manage an overall learning process for the user. It calls on the decision-making module 120 and receives a decision about what learning object to execute. It updates the user history 130 during each activation. Its function is fully described below. The decision-making module 120 determines the target learning item, that is, the word that the user selected in the text-reading interface 100, and what learning object would most effectively advance or grow the user's knowledge about the learning item in the current context of reading the current text. In the embodiment, it can use one or more system components to make its decision: the user history 130, the task context module 160, user information 170, and a learning-object library 150. A learning-object library 150 contains learning objects about vocabulary, which will be described below. User information 170 can include information such as the learning level of the user and a list of vocabulary items to focus on.

One skilled in the art will appreciate that the components illustrated in FIG. 1 may be implemented as separate components or several or all of them may be combined into a single component. For example, the learning management module 110 could be combined with the decision-making module 120. In this combination, the decision-making process could be more integrated with the management process to make decisions based on, say, the user's interaction with a learning object. In another combination, the text-reading interface 100 could incorporate the task context module 160. In this combination, the task interface would maintain its context internally and provide a method for the decision-making module 120 to query it. User history 130 and user information 170 could also be combined into a generalized user model.

The function of the components shown in FIG. 1 will now be described in greater detail.

The text-reading interface 100 is an interface for displaying an electronic text on a display and provides standard user controls for moving between pages and selecting words. When the user selects a word, the text-reading interface 100 sends a context record containing the selected word to the task context module 160, and notifies the learning management module 110 of the selection. The reading interface can allow a new text to be loaded into the system. When a new text is loaded, the reading interface can send a context record containing the important words of the new text to the task context module 160. The text-reading interface 100 can support various modes of operation including extensive reading mode and study mode. The former mode indicates that the user wishes to focus on reading fluency rather than vocabulary learning. In this mode, learning objects should help fluency in the current context and not unduly interrupt the user, so, for example, a quick gloss of how to pronounce a word or about a word's meaning is permissible. In study mode, the user wishes to focus on learning new vocabulary knowledge. In this mode, short interruptions are permissible, so activities and hints to aid memory can be provided. In both modes, it is preferable to minimize interruptions of the task of reading. When the mode is changed, the reading interface sends a context record to the task context module 160 as notification of the change.

A task context module 160 stores in a database or other storage system the current context of activity in the text-reading interface 100. A current context is a set of context records. The nature of the context records is dependent on the task and on the needs of the decision-making module 120. In the preferred embodiment, a context record can include the current word that a user is looking at, a word the user has selected, a set of words near a selected word in the text, a list of important or relevant words in the text, the current operation mode of the interface 100, the name or other identifier of the text, and the current page number of the text. These are examples only and are not intended to limit the scope of the system. Context records are used by the decision-making module 120 as decision-making criteria.

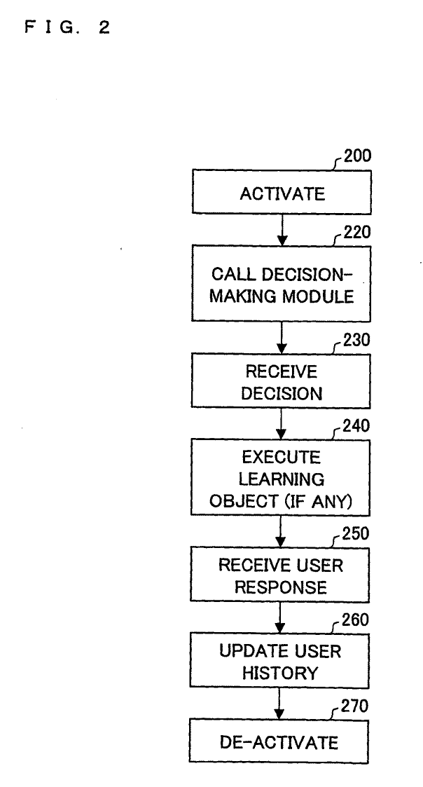

The learning management module 110 implements a learning management process as shown in the flowchart in FIG. 2. The first step 200 is activation of the module. Activation can occur in a variety of ways. In the preferred embodiment, the user of the reading interface 100 manually activates the system when the user wants to begin a learning cycle. For example, in a reading task, the user might select a word to activate the learning management module. After activation, the next step 220 it to make a decision by calling on the decision-making module 120. This process is described in more detail below. The next step 230 is to receive the decision from the decision-making module 120. The received decision can include several parts. One part is an identifier representing a word or phrase, called a target learning item, about which a learning activity will take place. Another part is a learning object. If the decision is to do nothing, then no learning object is received. In the next step 240, the module executes the learning object, if any. The next step 250 is to receive the user response or results of any interaction with the user that occurred in step 240. Step 260 then updates the user history 130. Step 260 generates one or more user history records. Types of user history records are given below. Step 260 then updates the history by sending the user history records to the user history 130. In the final step 270, the learning management module 110 deactivates itself, which puts the module into a waiting state for another activation.

The user history 130 tracks the user's growing knowledge of different vocabulary items, such as words or phrases. The user history 130 stores user history records in a database or other storage system. The user history can be persistent over the life of the user. A set of user history records is stored for each learning item. Each history record is given a timestamp. User history records can include: a record that the user has read a particular word in a text, a record that a user has selected a particular word in a text, a record that a user has previously requested help in relation to a particular word in a text, a record that a user has been presented a particular learning object about a particular word in step 240 in an activation cycle of the learning management module 110, a record that a user completed a particular learning object by giving a response in step 250, a record of a user's interaction with a particular learning object in step 250, including for example, a user response, an answer given to a hint or a quiz, a positive or negative result on a quiz, or the length of time spent with the learning object. The user history can also record the history of texts read by the user in the text-reading interface 100 and details of the changing context in the task context module 160 over time.

The decision-making module 120 determines the target learning item, or word, and selects a learning object to return to the learning management module 110. The goal of the decision-making process is to select a learning object that is most likely to advance a user's knowledge of a word given a user's history of encounters with the word.

Any particular method of making a decision can be implemented in the system. The method can therefore include any type of decision-making component or components including a fixed pattern or sequence of activities, a manually created decision tree, a decision tree generated by automatic decision tree learning, a method based on machine learning, an expert system (which can include a procedural inference engine and a separate rule base incorporating an instructional model about language learning), or any other inference system. The decision-making method employed will define the form of the decision-making criteria and how they are represented in the system. General categories of decision-making criteria can include, but are not limited to, the user's history of encountering a learning item, the user's history of interacting with learning objects about the learning item, the user's level or stage in learning, the level, stage, or difficulty of learning the item, a pedagogic model, the importance of the learning item in the current context of the task, the mode of the task interface, and the availability and suitability of learning objects in the library.

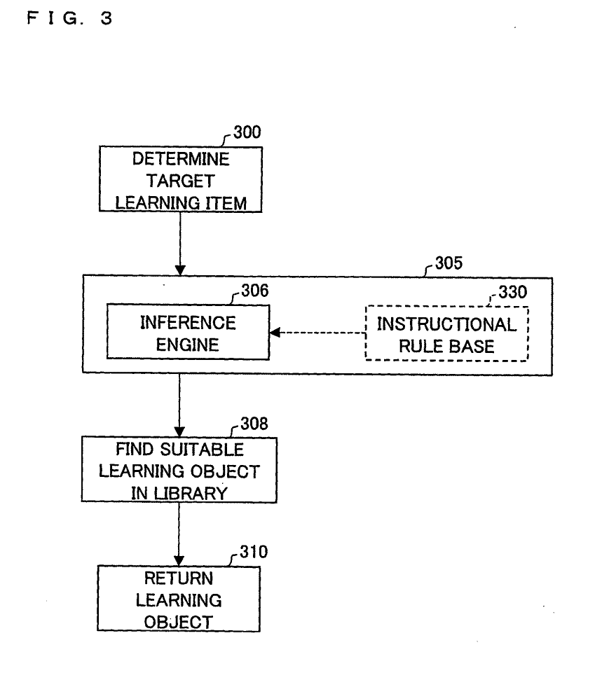

FIG. 3 is a flowchart of a generic decision-making method that can be implemented in the decision-making module 120. When called on to make a decision, it takes as input a task context 160, a user information 170, and a user history 130. In the preferred embodiment it uses a three stage process: determine the target learning item (that is, the user-selected word), determine a type of learning object to return, and determine the specific learning object to return. The first step 300 determines the target learning item in the current context. In the preferred embodiment this is the word that has been selected by the user in the text-reading interface 100, and stored in the task context 160. Step 305 runs an inference engine 306 to select the type of learning object to select. The engine can be simple, for example, following a pre-determined sequence of activities, or complex, for example implementing an instructional expert system. The function of instructional inference engines, or instructional expert systems, is well known in the prior art, and need not be explained in great detail here. The goal of the inference process is to determine, with sufficient probability, which type of learning object would most effectively advance the user's knowledge about the target learning item. An instructional model for teaching the target aspect of language (for example, vocabulary) can be implemented in an optional rule base 330 that encodes declarative rules, or as procedural steps in the inference engine 306. In the preferred embodiment, the latter method is used, and will be further described below. Step 308 finds a learning object in the learning-object library 150 that is a suitable match to the target learning item and to the type of learning object selected in step 305. Step 310 returns an identifier for the learning item and the learning object.

In the preferred embodiment, the decision-making module 120 contains an inference engine that uses procedural knowledge based on various factors, which are derived from theoretical principles of vocabulary acquisition as taught, for example, in Learning Vocabulary in Another Language by I. Nation, published by Cambridge University Press, 2001. A first factor is about whether the word should be focused on now or later. Words at the right level of difficulty for the user's current vocabulary level could be focused on now; words are typically ordered roughly by their frequency of use in the language. A second factor is about determining which aspect of vocabulary knowledge that the learner could focus on. Typically a learner could move from form (pronunciation and spelling), to meaning, to usage. A third is about determining the general type of learning object: informative, providing a hint, providing an activity requiring user interaction, or providing a tutorial. The fourth factor is to ensure that a range of particular learning objects are presented to the user over time, and that learning objects are not repeated unless necessary.

One skilled in the art will appreciate that there are many ways to use the above factors in a decision-making process. One or more of the factors may be applied in any given process. The factors may be applied in any order. The factors may be applied in separate decision steps or in any combination in a particular decision step. In the preferred embodiment, for a sequence of user selections of a given target word over time, the system can sequence corresponding learning objects first by aspect of knowledge (for example, form, then meaning, then usage), and second by type (for example, two glosses followed by an alternating sequence of activities and hints). The sequence is changed depending on the success and pace of the user.

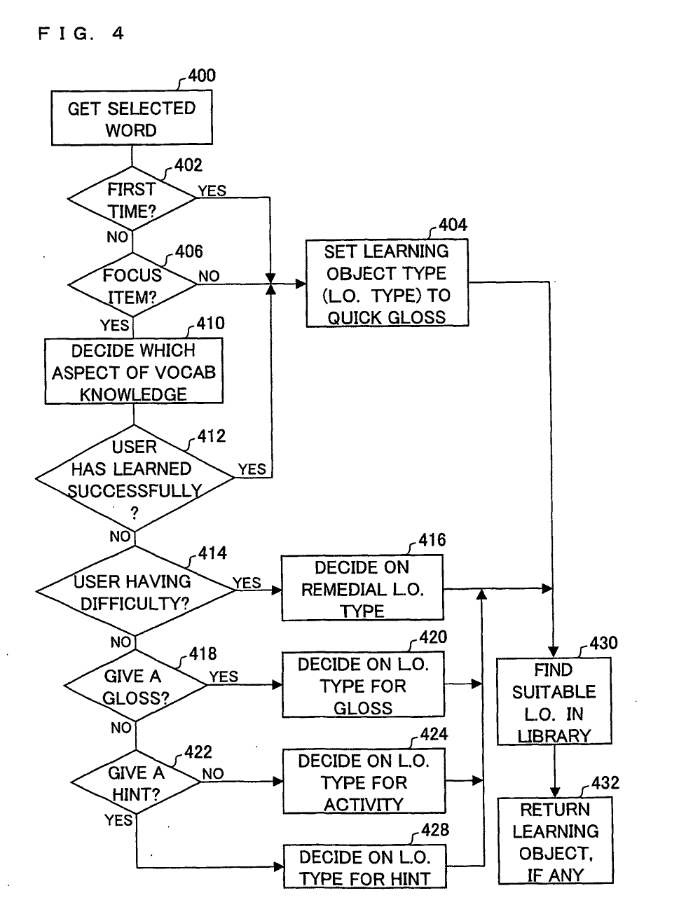

FIG. 4 is a flowchart of a decision-making method that can be implemented in the decision-making module 120 of an adaptive educational system for vocabulary learning. The first step 400 gets the word that the user selected in the reading interface from the task context module 160. The word is called the target learning item or target word. In the next step 402, the method determines if this is the first time the user has ever selected the word by consulting the user history 130. If yes, then step 404 sets the type of learning object to be a quick gloss. If no, then step 406 determines if the word is a focus item.

A focus item is a word that the user should focus on currently in learning. In practice, there are too many words in a language to learn them all at the same time, so a learner could instead learn words roughly in order of difficulty, which correlates with frequency in the language. That way, a learner can first learn the words that he or she is most likely to encounter in text and conversation. As a learner acquires sufficient knowledge of higher frequency words he or she can proceed to words of lower frequency. In this embodiment, the user information 170 includes a word list that contains the words at the right level of difficulty for the user to learn now, and other words deemed relevant for learning.

If the target word is on the word list in the user information 170 or the target word is important in the current text, determined from the task context 160, then the target word is a focus item. If the target word is not a focus item, then step 404 is processed, which sets the learning object type to quick gloss. A quick gloss of the target word will improve the reader's fluency in reading by helping him or her to understand the text without interrupting reading flow.

Step 410 determines what aspect of knowledge about the target word should be focused on now. For each aspect of form, meaning, and usage, the step consults the user history 130 to retrieve the set of history records about the user's encounter with the target word in learning objects about that aspect of knowledge. Then the step determines a probability of success in having learned that aspect of knowledge at the current time depending on the range of types of learning objects viewed or interacted with, the success rate, the time span, and/or the recency of interaction. The system assigns focus in the predetermined order of form, then meaning, and then usage. For a given aspect to be assigned as focus, the previous aspects must have been learned with a sufficiently high probability (for example, higher than 0.70) and the aspect itself must have been learned with a sufficiently low probability (for example, lower than 0.90). If more than one aspect meets this rule, then a random choice is made. It will be appreciated that the use of a probability value is only one example of a measure of the extent to which a user has successfully learned an aspect; for example the measure need not be expressed as a probability value between 0 and 1 but could be expressed as a value between any chosen limits. Some other measure of success could be used.

Step 412 determines if all aspects of the target word have been learned successfully, for example if the probability for each aspect is greater than 0.80. If the word has been successfully learned, then step 404 sets the learning object to quick gloss, in order to remind the user about the word. The fact that the learner selected the word even though they have ostensibly learned it means that the user might have forgotten some aspect of it. This fact can be used to lower the probability of having learned the word in a subsequent activation cycle.

Step 414 determines if the user is experiencing difficulty in learning the target word. If the success rate on the chosen aspect of knowledge is below a threshold, given a sufficient number of user attempts, then the system must take remedial action. The threshold parameter can be set to 30% success. If remedial action is called for, then step 416 determines, using the user history 130, what type of learning object should be selected. In this embodiment, the system can repeat the same learning object, repeat a previous learning object, move back to the previous aspect of word knowledge, or return an informative learning object.

If remedial action is not required, then step 418 determines if the type of learning object should be informative, also called a gloss. A gloss is called for if the reading interface 100 is in extensive reading mode, if the word is not important in the text, or if the number of times a gloss of the current aspect of word knowledge (form, meaning, or usage) has been returned is below a threshold. The threshold is a parameter, and can be set to 3 in this embodiment, so that 2 glosses for each aspect of word knowledge are shown before presenting other types of learning object. If a gloss is decided, then step 420 determines what kind of gloss should be used.

If a gloss is not required, then step 422 determines if the type of learning object should be a hint or an activity. In this embodiment, the system alternates between activities and hints. Step 424 determines what type of hint to return, which can be related to any previous learning activity. Step 428 determines what type of activity to return.

Thus, in summary, if the user is successful in learning a given aspect over time then steps 410-428 will present the following sequence of general learning object types: gloss, gloss, activity, hint, activity, hint, activity, hint, and so on. A similar sequence for the other aspects of knowledge would be interleaved with this one depending on the user's success over time.

After the system sets the type of learning object, step 430 searches the learning-object library 150 for a suitable matching learning object. This can be a learning object for the target word, of the chosen type and aspect, and one that does not repeat a previously returned learning object, unless called for or unless necessary.

Finally, step 432 returns the word and the learning object to the learning management module 110.

The parameters identified in the above specification of the preferred embodiment have been set at typical and effective values, but in a system they can be set at different values and even changed over the course of execution of the system by system internal or external processes. Such parameters can be stored on an individual user basis in the user information 170. The user information 170 can store any type of user-specific data, such as personal preferences, personal characteristics, age, country of residence, and so on.

The learning-object library 150 is a database, or other storage system, of learning objects. The library can be queried to retrieve a suitable learning object. Each learning object can include a learning item (or identifier thereof), metadata indicating the type, category, aspect, or other features about the learning object, and an executable function or process. Any kind of learning object is supported by the system, although it is preferred that they be short to execute. By short is meant, for example, that a learning object has a sufficiently small amount of content so that it can be displayed on a single screen or page, that it focus on only one aspect of knowledge about a learning item, or that it takes a short time for the user to read, listen to, or interact with. Learning objects are intended to be educational and can incorporate any known or future pedagogical method such as: presenting, testing, reviewing, hinting, coaching, explaining, demonstrating, helping, tutoring, and negotiating, each of which could represent a different kind of learning object. A few general categories of learning object are provided in the preferred embodiment. One general category of learning object is an object that when executed does not require interaction with the user. A learning object that does not require user interaction can include, for example, displaying static information for a short time, playing a short presentation, animation, video, or audio segment. The second category requires a simple response from the user and can include, for example, showing static or dynamic information, as above, but requesting the user to confirm that they have watched or listened to it. A third category requires an interaction with the user, for example, an interactive session such as a quiz or other learning activity in which the user interacts for a period of time and then finishes, having provided an answer or other input. One skilled in the art will appreciate that these are examples only and do not limit the system in any way. The length of time that a learning object is likely to take to complete can be taken into account when selecting a suitable learning object to present to the user. In the preferred embodiment, examples of vocabulary learning objects that teach the form aspect of knowledge can include: system pronouncing the word with audio (gloss), system showing a phonetic or phonemic transcription (gloss), a listen and repeat (activity), spelling test (activity), user practicing writing a word (activity), a multiple choice question (activity), a pronunciation guide for part of the word (hint), system showing a rhyming word (hint). Examples of learning objects that teach the meaning aspect of knowledge can include: system showing a translation (gloss), system showing a definition (gloss), system showing an image (gloss), user drawing a picture of the word (activity), having the user select a mnemonic keyword (activity), a multiple choice question (activity), system showing a synonym (hint), system showing the drawn image (hint), system showing the mnemonic keyword (hint), system showing the answer to a multiple choice question (hint). Examples of learning objects that teach the usage aspect of knowledge can include: system showing an example of usage (gloss), system showing a collocation or phrase (gloss), a multiple choice question (activity), a gap-filling activity (activity), system showing the answer to a previous multiple choice (hint), system showing the answer to a gap-filling task (hint). These are examples only and do not limit in any way the full range of vocabulary learning objects that the system can support.

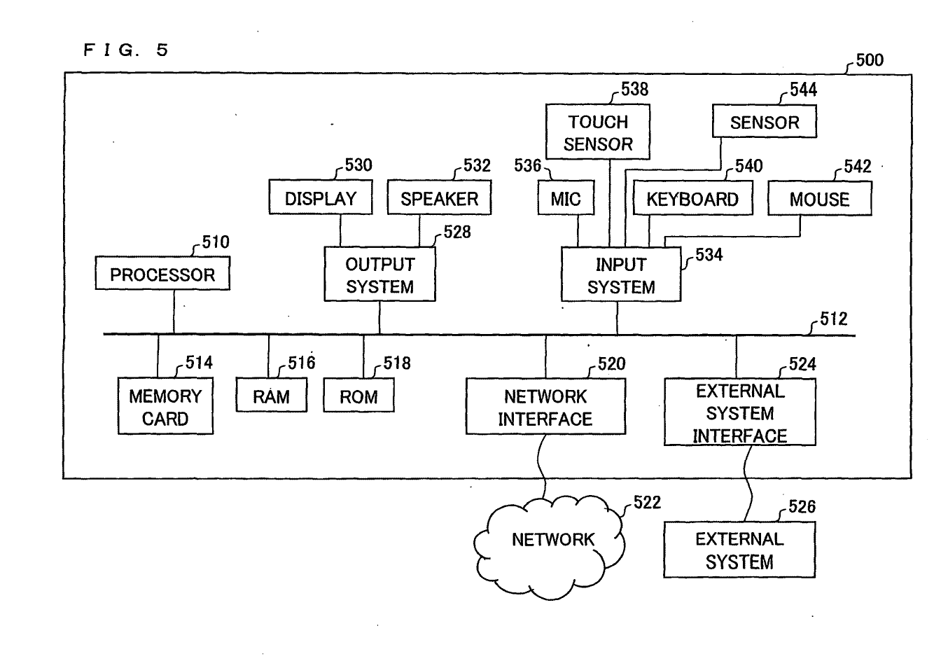

FIG. 5 is a block diagram of a computer system 500 that is suitable for practicing the preferred embodiment or any other embodiment. Those skilled in the art will appreciate that the system depicted in FIG. 5 is meant for illustrative purposes only and that other system configurations are suitable including personal computer systems, portable computer systems, and distributed computer systems. The computer system 500 includes a processor 510, memory card 514, RAM 516, and ROM 518. It also includes an output system 528 and an input system 534. Output devices include a display 530 and a speaker 532. Input devices include a microphone 536, a touch sensor 538, a keyboard 540, a mouse 542, and other sensors 544. The system can also include a network interface 520 that interfaces with an external computer network 522 using wired or wireless technologies. The system can also include an external system interface 524 that interfaces with external system 526 such as a physical book reading device or a musical instrument. A system bus 512 interconnects all of the components. Those skilled in the art will appreciate that an adaptive educational system can be integrated into the system 500 by including it as software in the memory card 514, the RAM 516, the ROM 518, or as hardware in a dedicated hardware chip that can, optionally, include the processor 510. The text-reading interface 100 can be integrated into the computer system 500 or into the external system 526, as is further described in a variation below.

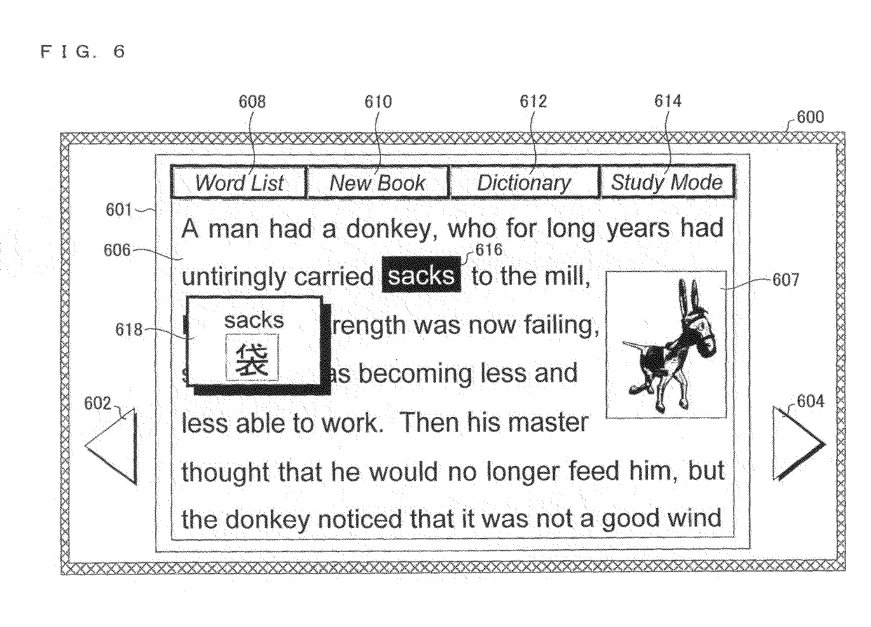

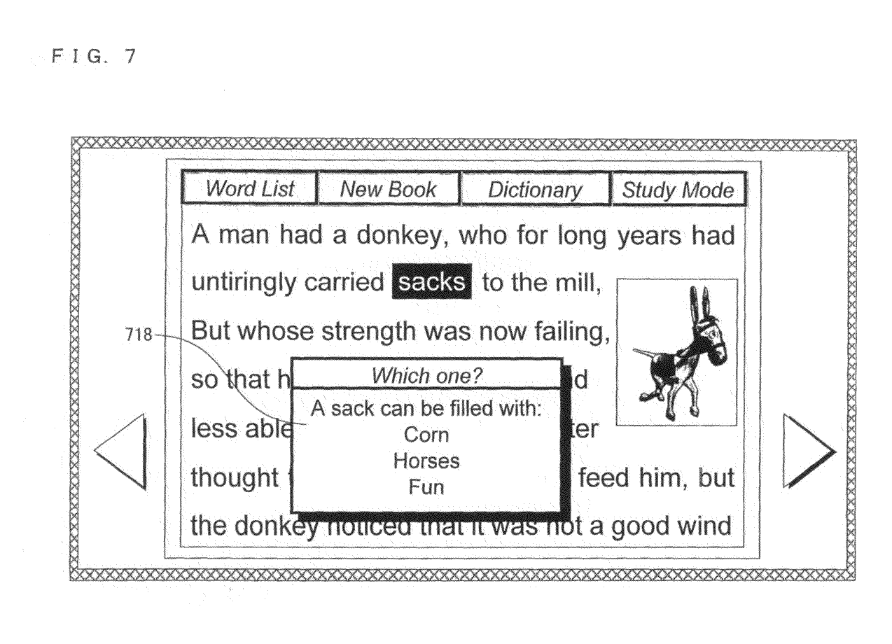

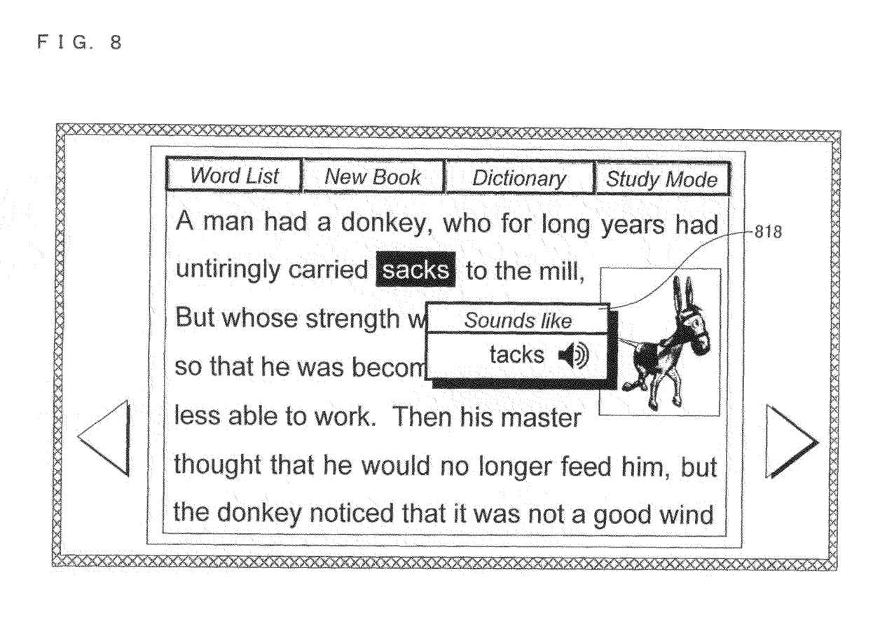

FIGS. 6, 7, and 8 show the front view of an exemplary educational device 600 and user interface for electronic book reading that incorporates an adaptive educational system for vocabulary learning. Those skilled in the art will appreciate that the device depicted in FIG. 6 is meant to be illustrative only and that other device designs can be used. Device 600 is preferably a portable device that incorporates a computer system, for example, computer system 500, having a display 601, and a page left button 602, and a page right button 604. The display 601 has a touch sensor interface layered over it, which is not shown in the figures. Display 601 shows a text-reading interface 100. On the display is shown a portion of text 606 of a story book and an image 607 related to the story. The display 601 also shows four exemplary buttons: a Word List button 608 for displaying the user's current word list, a New Book button 610 for starting a new book, and a Study Mode button 612 for switching the reading interface into study mode. Button 614 would then change function to switch back Extensive Reading Mode. Word 616 is highlighted on the display, indicated that the user has selected this word by touching it. Box 618 shows a learning object of type gloss (a translation of the word “sacks” into Chinese language) that the learning management module 110 has executed and displayed on the screen. In FIG. 7, the user has selected the same word again, but this time, box 718 shows a learning object of type activity (a multiple choice question). In FIG. 8, the user has again selected the same word, and this time the system has adapted to the user's growing knowledge about the word “sacks” and displayed box 818 which shows a learning object of type hint (a hint about the pronunciation).

In one variation of the preferred embodiment, step 200 determines automatically when to activate itself and provide an intervention. One method is to automatically activate at preset points in the task progress (for example, at the end of a page), or at preset time intervals. Another method is to determine automatically, using an inference system that monitors events in the task interface 100, when the user appears to be having difficulty performing a task, as is taught in U.S. Pat. No. 6,262,730 and other prior art.

In another variation of the preferred embodiment, an eye-gaze tracking system is included in the reading interface 100, as is taught in the paper Proactive Response to Eye Movements by Hyrskykari et al. published in Human-Computer Interaction INTERACT'03, pp. 129-136, 2003. Eye tracking can be used to detect comprehension problems of a user in the reading of a text. In this embodiment, eye-gaze information could be sent to the task context module 160 so that the decision-making module 120 can determine which words in the text have been viewed, how often, or at what speed, which can inform the decision-making process. In this way, a learning object can be selected in dependence upon a monitoring of the user's direction of gaze over one or more periods of time. Additionally, when a comprehension problem is detected, the reading interface can automatically activate the learning management module 110 while providing the locus of the comprehension problem to the task context module 150.

In another variation of the preferred embodiment, the reading interface 100 can be a physical interface, which can involve a physical text such as a real book. The interface can detect when a finger or pen is touched to a word in the book, as provided in prior art systems such as the LeapPad® learning system manufactured by LeapFrog® Enterprises. In this embodiment, the physical task interface 100 is separate and coupled to a separate system that consists of a learning management module 110, a task context module 160, a decision-making module 120, a user history 130, a learning-object library 150, and user information 170. Referring to FIG. 5, this embodiment could be practiced by implementing the task interface in an external system 526, and implementing the separate system as a computer system 500, using its external system interface 524 as a means for coupling the two parts together. In this embodiment, the learning management module 110 could monitor the physical task interface for touch events on the physical task interface and then activate itself.

It will therefore be apparent that the various parts of the apparatus, and the method steps that are performed by those respective parts, can be separate and remote from one another. At least one of the steps of designating a learning item, selecting a learning object, presenting the learning object and updating the user information can be performed remotely from at least one other of those steps; for example at least one of the selecting and updating steps could be performed remotely from at least one of the designating and presenting steps. Presenting the learning object could comprise providing information to enable presentation at a remote device, for example a remote device of the user.

In another variation of the preferred embodiment, the learning-object library 150 can be augmented with learning objects that come packaged with a text or book that is loaded into task interface 100. For example, learning objects that are relevant to characters and events in a book can then be made available to the system and the user.

In another variation of the preferred embodiment, a single user history 130 can be maintained across a range of different task interfaces for a variety of domains, subjects, and skills to be learned. The user history 130 can be considered personal to the user, and portable between different devices; for this purpose the user history 130 (the whole or part of it) can be stored on a removable computer-readable medium.

One skilled in the art will appreciate that other embodiments of the present invention can be applied to learning any aspect of language including, but not limited to, and in any combination, vocabulary, grammar, pronunciation, spelling, and discourse.

One skilled in the art will also appreciate that other embodiments of the present invention can be applied to any type of task that requires language skills, including, but not limited to, and in any combination, reading, writing, listening, speaking, translation, and conversation.

One skilled in the art will also appreciate that the internal function of the system components and the items and records that are passed between them will vary with the type of task and the target subject or skill to be learned.

One skilled in the art will also appreciate that other embodiments of the present invention can be applied to other domains, subjects, disciplines, and skills, such as mathematics, natural sciences, social sciences, music, art, geography, history, culture, technology, business, economics, and a variety of training and education scenarios not limited by this list.

It will be appreciated that operation of one or more of the above- or below-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

1. A computer-implemented adaptive learning method, for performance within the context of a task being carried out by a user, the method comprising:
designating as a learning item at least one of a sequence of elements presented to the user as part of the task;
selecting a learning object in dependence upon the designated learning item, information relating to previous performance of the learning method in relation to the user, and a predetermined scheme devised to manage an overall learning process for the user, presentation of the selected learning object to the user being intended to advance the user's knowledge of the designated learning item in some way;
presenting the learning object to the user; and
updating the information in dependence upon the presented learning object and/or how the user interacts with or responds to the presented learning object,
wherein the learning object is selected in dependence on the user's current knowledge of the learning item, which is estimated as a result of the user's performance on learning objects.

2. A method as claimed in claim 1, wherein the task is an authentic task, not designed for the sole purpose of supporting the adaptive learning method.

3. A method as claimed in claim 1, comprising watching for the selection of at least one element by the user, and designating the learning item in dependence upon the selection.

4. A method as claimed in claim 1, comprising automatically designating the learning item.

5. A method as claimed in claim 1, comprising presenting the sequence of elements to the user.

6. A method as claimed in claim 1, wherein selecting the learning object comprises determining the category of the learning object, and selecting the particular learning object in dependence upon the determined category.

7. A method as claimed in claim 6, wherein the categories of the learning object comprise one or more of: those that do not require user interaction; those that require a simple response from the user; and those that require more involved interaction with the user.

8. A method as claimed in claim 1, wherein selecting the learning object comprises determining whether the learning item should be focused on now or later by the user.

9. A method as claimed in claim 1, wherein the presentation of the selected learning object is intended to advance a particular aspect of the user's knowledge of the designated learning item.

10. A method as claimed in claim 9, wherein selecting the learning object comprises determining the aspect of knowledge of the desired learning item on which the user should focus.

11. A method as claimed in claim 9, wherein the aspect of knowledge comprises at least one of: form; meaning; and usage.

12. A method as claimed in claim 11, comprising prioritising the aspects in that order where possible.

13. A method as claimed in claim 9, comprising, for each aspect, determining a probability that the user has successfully learned that aspect, or some similar measure of success, and choosing the learning object in dependence upon the determined probabilities.

14. A method as claimed in claim 13, comprising selecting the aspect for focus if that aspect has a probability below a predetermined threshold, and other aspects having a higher learning priority have respective probabilities above a predetermined threshold.

15. A method as claimed in claim 13, comprising deciding to take remedial action in relation to the aspect, and to select a learning object accordingly, if that aspect has a success rate over time below a predetermined threshold.

16. A method as claimed in claim 1, wherein selecting the learning object comprises determining a general type of learning object from one or more of the following: informative, providing a hint, providing an activity requiring user interaction, or providing a tutorial.

17. A method as claimed in claim 1, wherein the learning object is selected to attempt to ensure that a range of the learning objects are presented to the user over time, and that the learning objects are not repeated unless necessary.

18. A method as claimed in claim 1, wherein the learning object is selected from a library of learning objects.

19. A method as claimed in claim 1, comprising selecting the learning object in dependence upon the designated learning item's context within the sequence.

20. A method as claimed in claim 19, wherein a learning item's context comprises at least one of: a page number in the sequence of a page containing at least part of the learning item; an element or elements currently being considered by the user; an element or elements in proximity to at least one of the at least one item making up the designated learning item; an element or elements considered important or relevant to the method; and a name or other identifier of the sequence.

21. A method as claimed in claim 1, comprising selecting the learning object in dependence upon an assessment of the importance of the designated learning item.

22. A method as claimed in claim 1, comprising selecting the learning object in dependence upon a predetermined list of important or relevant elements in the sequence.

23. A method as claimed in claim 1, wherein the information comprises one or more of the following: a list of items at the right level of difficulty for the user; a list of items deemed relevant for learning; items that have been encountered previously; items that have been designated previously as learning items; learning objects that have previously been presented; learning objects requiring a response that have previously been presented; information relating to the user's previous interaction with learning objects, such as a response, answers given to a hint or a quiz, a positive or negative result on a quiz, or the length of time spent with the learning object; sequences previously read by the user; information relating to the changing context in a task context module over time; a past history of encounters with different items; recency of interaction with learning objects; the user's level or stage in learning; the level, stage, or difficulty of a learning item.

24. A method as claimed in claim 1, comprising storing the information in a database or other storage system.

25. A method as claimed in claim 24, wherein the at least part of the information is stored on removable computer-readable media.

26. A method as claimed in claim 1, wherein at least part of the information is persistent over the life of the user.

27. A method as claimed in claim 1, wherein information is maintained relating to each learning item encountered.

28. A method as claimed in claim 27, wherein the information relating to each encountered learning item is timestamped.

29. A method as claimed in claim 1, comprising selecting the learning object in dependence upon user information not relating to previous performance of the learning method, such as personal characteristics of the user.

30. A method as claimed in claim 1, comprising selecting the learning object in dependence upon the likelihood of the learning object advancing user knowledge of the designated learning item.

31. A method as claimed in claim 1, comprising providing at least two modes of operation, and selecting the learning object in dependence upon the mode of operation.

32. A method as claimed in claim 1, comprising selecting the learning object in dependence upon a likely performance time for the learning object.

33. A method as claimed in claim 1, wherein the learning object requires a relatively small amount of time to complete in relation to the task and is not overly detracting from the performance of the task.

34. A method as claimed in claim 1, comprising selecting the learning object from one or more of the following types of learning object: presenting; testing; reviewing; hinting; coaching; explaining; demonstrating; helping; tutoring; and negotiating; each in relation to the designated learning item.

35. A method as claimed in claim 1, comprising selecting the learning object in dependence upon a rule base that encodes declarative rules.

36. A method as claimed in claim 1, comprising selecting the learning object in dependence upon procedural steps in an inference engine.

37. A method as claimed in claim 1, comprising selecting the learning object in dependence upon a monitoring of the user's direction of gaze over one or more periods of time.

38. A method as claimed in claim 1, wherein presenting the sequence and/or learning object comprises presenting it in a visual and/or audio format.

39. A method as claimed in claim 1, wherein the task is one that is chosen independently by the user.

40. A method as claimed in claim 1, wherein the sequence of elements comprises at least some elements in a visible form, at least when presented.

41. A method as claimed in claim 1, wherein the sequence of elements comprises at least some element in an audible form, at least when presented.

42. A method as claimed in claim 1, wherein the sequence of elements is presented in the form of a document.

43. A method as claimed in claim 42, wherein the document comprises printed material.

44. A computer-implemented adaptive language learning method as claimed in claim 1, wherein: the elements are words or phrases or segments of text; the task is one or more of reading, writing, listening, speaking, translation, conversation; and learning objects are adapted to advance the user's knowledge of one or more of: vocabulary, grammar, pronunciation and discourse.

45. A method as claimed in claim 44, wherein the aspect of knowledge comprises at least one of: form; meaning; and usage, and
wherein the vocabulary learning objects that teach the form aspect of knowledge comprise one or more of the following: those that pronounce the word with audio; those that show a phonetic or phonemic transcription; those that provide a listen and repeat activity; those that provide a spelling test; those that provide an activity in which the user practices writing a word; those that provide a multiple choice question activity; those that provide a pronunciation guide for at least part of the word; and those that provide a hint showing a rhyming word.

46. A method as claimed in claim 44 wherein the aspect of knowledge comprises at least one of: form; meaning and usage, and
wherein the learning objects that teach the meaning aspect of knowledge comprise one or more of the following: those that show a translation; those that show a definition; those that show an image; those that provide an activity in which the user draws a picture of the word; those that provide an activity in which the user selects a mnemonic keyword; those that provide a multiple choice question activity; those that show a synonym; those that show a drawn image; those that show a mnemonic keyword; and those that show the answer to a multiple choice question.

47. A method as claimed in claim 44, wherein the aspect of knowledge comprises at least one of: form; meaning; and usage, and
wherein learning objects that teach the usage aspect of knowledge comprise one or more of the following: those that show an example of usage; those that show a collocation or phrase involving the learning item; those that provide a multiple choice question activity; those that provide a gap-filling activity; those that show the answer to a previous multiple choice; and those that show the answer to a gap-filling task.

48. A method as claimed in claim 1, implemented using a portable electronic device such as a Personal Digital Assistant or electronic book reading device.

49. A method as claimed in claim 1, implemented using a personal computer.

50. A method as claimed in claim 1, comprising watching for the selection of at least one element using a touch sensitive interface.

51. A method as claimed in claim 1, wherein at least one of the designating, selecting, presenting and updating steps is performed remotely from at least one other of those steps, for example at least one of the selecting and updating steps being performed remotely from at least one of the designating and presenting steps.

52. A method as claimed in claim 1, wherein presenting comprises providing information to enable presentation at a remote device, for example a remote device of the user.

53. A computer-implemented adaptive learning method, for performance within the context of a task being carried out by a user, the method comprising:
selecting a learning object in dependence upon a designated learning item, the designated learning item comprising at least one of a sequence of elements presented to the user as part of the task, and upon information relating to previous performance of the learning method in relation to the user, and upon a predetermined scheme devised to manage an overall learning process for the user, presentation of the selected learning object to the user being intended to advance the user's knowledge of the designated learning item in some way; and
updating the information in dependence upon the selected learning object and/or how the user interacts with or responds to the selected learning object,
wherein the learning object is selected in dependence on the user's current knowledge of the learning item, which is estimated as a result of the user's performance on learning objects.

54. An adaptive learning apparatus for use in performing an adaptive learning method within the context of a task being carried out by a user, the apparatus comprising:
means for designating as a learning item at least one of a sequence of elements presented to the user as part of the task;
means for selecting a learning object in dependence upon the designated learning item, information relating to previous performance of the learning method in relation to the user, and a predetermined scheme devised to manage an overall learning process for the user, presentation of the selected learning object to the user being intended to advance the user's knowledge of the designated learning item in some way;
means for presenting the learning object to the user; and
means for updating the information in dependence upon the presented learning object and/or how the user interacts with or responds to the presented learning object,
wherein the learning object is selected in dependence on the user's current knowledge of the learning item, which is estimated as a result of the user's performance on learning objects.

55. An adaptive learning apparatus for use in performing an adaptive learning method within the context of a task being carried out by a user, the apparatus comprising:
means for selecting a learning object in dependence upon a designated learning item, the designated learning item comprising at least one of a sequence of elements presented to the user as part of the task, and upon information relating to previous performance of the learning method in relation to the user, and upon a predetermined scheme devised to manage an overall learning process for the user, presentation of the selected learning object to the user being intended to advance the user's knowledge of the designated learning item in some way; and
means for updating the information in dependence upon the selected learning object and/or how the user interacts with or responds to the selected learning object,
wherein the learning object is selected in dependence on the user's current knowledge of the learning item, which is estimated as a result of the user's performance on learning objects.

56.-58. (canceled)

59. A program for controlling an apparatus to perform a method as claimed in claim 1, wherein the program is carried on a storage medium.

60. (canceled)

61. An apparatus programmed by a program as claimed in claim 59.

62. A storage medium containing a program as claimed in claim 59.

63. A computer-implemented adaptive learning method, for performance within the context of a task being carried out by a user, the method comprising:
designating as a learning item at least one of a sequence of elements presented to the user as part of the task;
selecting a learning object in dependence upon the designated learning item, information relating to previous performance of the learning method in relation to the user, and a predetermined scheme devised to manage an overall learning process for the user, presentation of the selected learning object to the user being intended to advance the user's knowledge of the designated learning item in some way;
presenting the learning object to the user; and
updating the information in dependence upon the presented learning object and/or how the user interacts with or responds to the presented learning object,
wherein the learning object is selected in dependence on the user's current knowledge of the learning item, which is estimated from a probability of having learned the learning item.
